(19) United States
(12) Patent Application Publication
(10) Pub. No.: US 2021/0021471 A1
(43) Pub. Date: Jan. 21, 2021

(54) TECHNIQUES FOR MANAGING VIRTUAL NETWORKS

(71) Applicant: Microsoft Technology Licensing, LLC, Redmond, WA (US)

(72) Inventors: Karthick JAYARAMAN, Kirkland, WA (US); Parag SHARMA, Issaquah, WA (US); Ashish BHARGAVA, Sammamish, WA (US); Ryan BECKETT, Seattle, WA (US)

(21) Appl. No.: 16/511,732

(22) Filed: Jul. 15, 2019

(51) Int. Cl. H04L 12/24; H04L 12/46; G06F 9/455; G06F 9/451; H04L 29/06

(52) U.S. Cl. CPC H04L 41/0893; H04L 12/4641; H04L 41/0803; G06F 2009/45595; G06F 9/45558; G06F 9/451; H04L 63/20; H04L 41/20

(57) ABSTRACT

Examples described herein generally relate to determining a current network state of the set of virtual networks, detecting, based at least in part on obtaining at least a portion of a high-level virtual network policy, an indicated change to the current network state, compiling, based on detecting the indicated change, at least a portion of the high-level virtual network policy to generate a set of low-level intermediate representation instructions to implement the indicated change to the high-level virtual network policy, and applying the set of low-level intermediate representation instructions in a network configuration for managing the set of virtual networks.

### BACKGROUND

Large-scale networked systems are provided as platforms employed in a variety of settings for running service applications and maintaining data for business and operational functions. Such networks can include and/or be a part of a data center (e.g., a physical cloud computing infrastructure) that may provide a variety of services (e.g., web applications, email services, search engine services, resource sharing services, etc.) for client computing devices connected to at least a portion of the network. These large-scale networked systems typically include a large number of resources distributed throughout the data center, where each resource can include or at least resemble a physical machine or a virtual machine running on a virtualized physical host (referred to as a “virtual network resource”).

In addition, emerging technologies can be employed to generate isolated groups of virtual network resources (e.g., referred to as “virtual networks” or “VNets”) for deploying network functionality within the isolated groups and among the virtual network resources within the isolated groups. For example, a Software-Defined Network (SDN) function can be provided to maintain and/or control interconnection between virtual network resources in a virtual network based on their underlying physical network architecture. For example, a SDN function can define virtual network resources as peers in the virtual network, though the underlying physical network architecture may involve traversing a larger number of nodes, among physical and/or virtually defined networks, to associate the virtual network resources as peers. Administrators can configure the SDN function (or one or more SDN functions) to achieve a desired functionality for one or more virtual networks.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In an example, a computer-implemented method for managing a set of virtual networks is provided. The method includes determining a current network state of the set of virtual networks, detecting, based at least in part on obtaining at least a portion of a high-level virtual network policy, an indicated change to the current network state, compiling, based on detecting the indicated change, at least a portion of the high-level virtual network policy to generate a set of low-level intermediate representation instructions to implement the indicated change to the high-level virtual network policy, and applying the set of low-level intermediate representation instructions in a network configuration for managing the set of virtual networks.

In another example, a computing device for managing a set of virtual networks is provided. The computing device includes a memory storing one or more parameters or instructions for compiling source code, and at least one processor coupled to the memory. The at least one processor is configured to determine a current network state of the set of virtual networks, detect, based at least in part on obtaining at least a portion of a high-level virtual network policy, an indicated change to the current network state, compile, based on detecting the indicated change, at least a portion of the high-level virtual network policy to generate a set of low-level intermediate representation instructions to implement the indicated change to the high-level virtual network policy, and apply the set of low-level intermediate representation instructions in a network configuration for managing the set of virtual networks.

In another example, a non-transitory computer-readable medium including code executable by one or more processors for managing a set of virtual networks is provided. The code includes code for determining a current network state of the set of virtual networks, detecting, based at least in part on obtaining at least a portion of a high-level virtual network policy, an indicated change to the current network state, compiling, based on detecting the indicated change, at least a portion of the high-level virtual network policy to generate a set of low-level intermediate representation instructions to implement the indicated change to the high-level virtual network policy, and applying the set of low-level intermediate representation instructions in a network configuration for managing the set of virtual networks.

To the accomplishment of the foregoing and related ends, the one or more examples comprise the features hereinafter fully described and particularly pointed out in the claims. The following description and the annexed drawings set forth in detail certain illustrative features of the one or more examples. These features are indicative, however, of but a few of the various ways in which the principles of various examples may be employed, and this description is intended to include all such examples and their equivalents.

### BRIEF DESCRIPTION OF THE DRAWINGS

FIG. 1 is a schematic diagram of an example of a computing device for compiling high-level virtual network policies in accordance with examples described herein.

FIG. 2 is a flow diagram of an example of configuring a network based on a compiled high-level virtual network policy in accordance with examples described herein.

FIG. 3 is a flow diagram of a process for generating or updating a network configuration based on a compiled high-level virtual network policy in accordance with examples described herein.

FIG. 4 is a schematic diagram of an example of a computing device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various examples related to managing one or more virtual networks via a Software-Defined Network (SDN) function, where the SDN function can configure and/or maintain certain functionalities for the one or more virtual networks. Based on the number of virtual network resources, the underlying physical network resources, the existing definitions of virtual networks, etc. for the virtual network(s), configuring the SDN function to achieve a desired functionality or goal state for the virtual network(s) using conventional mechanisms may become complicated and time-consuming for an administrator. In addition, and in this regard, human-error may be introduced in the configuration. For example, there are several types of configurations that can be possible for virtual networks and/or the associated virtual network resources, such as peering, segmentation, routing, isolation, and security policies. The semantics of each of these configurations can be uncooperative for human inspection particularly at scale. Administrator can build custom automations to generate these policies, or rely on third party providers; however, these automations do not offer correct-by-construction guarantees when transitioning from one network state to another.

Accordingly, aspects described herein relate to defining high-level specifications and abstractions for stating policy intent for virtual networks, where a goal state can be generated based on the policy intent along with a consistent sequence of operations to achieve the goal state (e.g., to transition from a current state to the goal state). In one example, this can be achieved by providing a SDN compiler for generating a set of low-level intermediate representation instructions for the SDN function based on a specified high-level network policy. This can allow an administrator to specify, modify, etc. a high-level network policy to achieve the goal state for the one or more virtual networks. For example, the SDN compiler can receive the high-level network policy and/or associated policy modifications as input, and can generate the set of low-level intermediate representation instructions as output. The SDN function can then apply the set of low-level intermediate representation instructions as one or more parameters in a network configuration to achieve the goal state indicated by the high-level network policy.

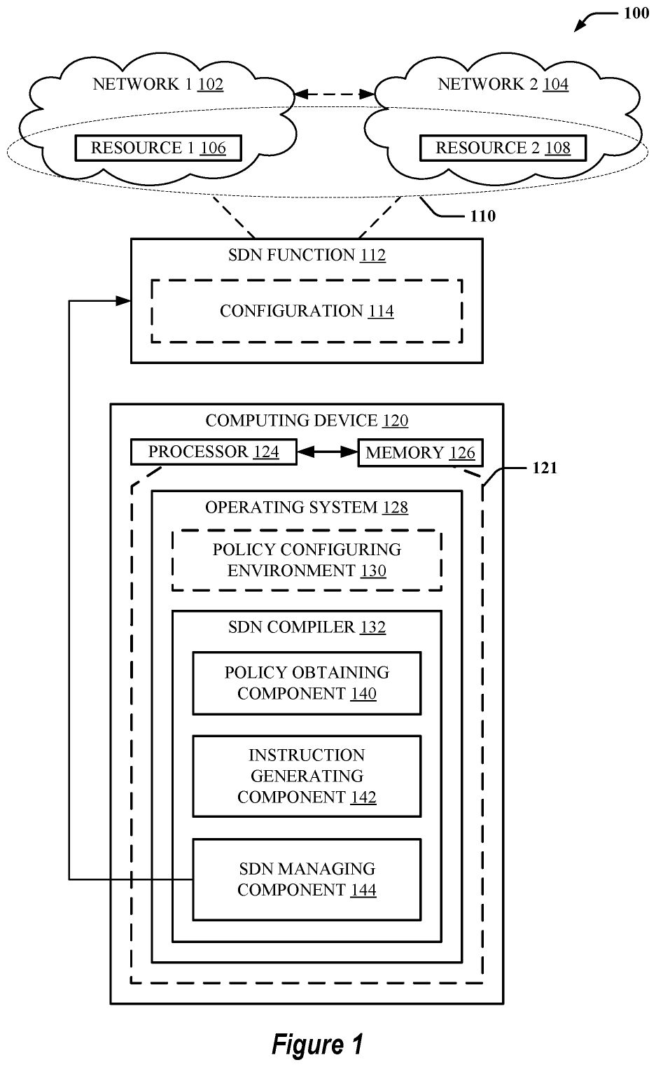

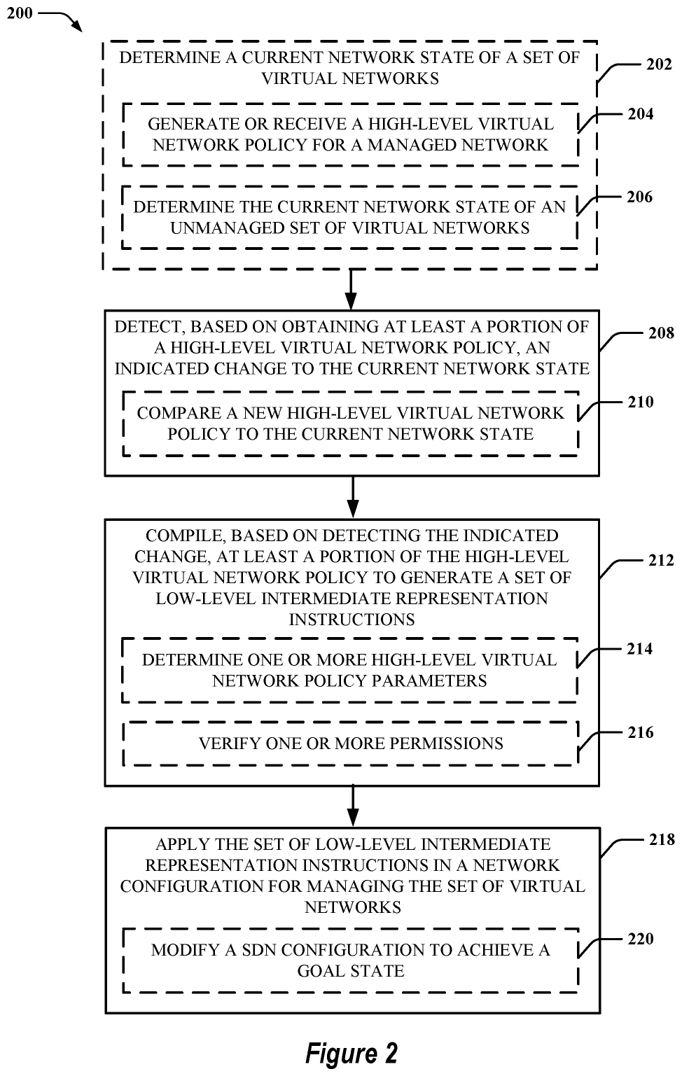

Turning now to FIGS. 1-4, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the following actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a wireless communication system 100 that includes one or more networks, such as network 1 102 and/or network 2 104. Network 1 102 and/or network 2 104 can be physical networks having associated resources, such as resource 1 106 in network 1 102 and resource 2 108 in network 2 104. The resources within a given network can be configured to communicate with one another via physical or virtual attachment with one another to form the network. For example, the resources can include a network interface card or other hardware for physical (e.g., wired or wireless) attachment to one or more other resources in the network. In addition, network 1 102 and network 2 104 may be configured to communicate with one another using one or more resources, such as one or more routers, bridges, firewalls, web servers, load balancers, databases, or other physical network hardware. In one example, network 1 102 and network 2 104 may access one another (or resources thereof may facilitate access with one another) over the Internet.

In one example, resource 1 106 and resource 2 108 may be virtualized as virtual network resources that map to the physical resource 1 106 and resource 2 108 on corresponding network 1 102 and network 2 104. As such, for example, resource 1 106 and resource 2 108 can be associated as part of a virtual network (VNet) 110. For example, an association between virtual network resources can include a peering policy to associate the virtual network resources as peers (e.g., that can access one another), a segmentation policy to associate partition resources into segments, a security policy that specifies which resource can access another resource, etc. An SDN function 112 can manage the virtual network 110 by instituting one or more parameters or rules to facilitate association among virtual network resources. For example, packets to be communicated among the virtual network can traverse the SDN function to facilitate communicating the packets (or rejecting the packets) based on the peering, segmentation, routing, isolation, security policies, etc. Moreover, for example, the virtual network can be segmented into one or more subnets with a portion of network address space, where each subnet can include its own resources.

In one example, the SDN function 112 may be provided by a resource of one or more of the networks (e.g., network 1 102 or network 2 104) and/or of a network that can communicate with both of the networks, etc. For example, the SDN function 112 can allow for specifying access control lists (ACLs) or other user defined rules, security groups, and/or the like, in a configuration 114, and can utilize the ACLs and/or other rules, groups, etc. in the configuration 114 to determine how to communicate packets that traverse the SDN function 112. As described, the SDN function 112 may allow for manually specifying the ACLs, rules, groups, etc., but this may become burdensome given the complexity of the virtual network(s) operating using the SDN function 112 and/or the desired goal state or functionality for the virtual network(s).

Accordingly, a computing device 120 and/or related components for a compiling a high-level virtual network policy into low-level intermediate representation instructions for managing a SDN are provided and described in accordance with aspects described herein. For example, computing device 120 can include or can otherwise be coupled with a processor 124 and/or memory 126, where the processor 124 and/or memory 126 can be configured to execute or store instructions or other parameters related to managing an SDN, as described herein. For example, processor 124 and memory 126 may be separate components communicatively coupled by a bus (e.g., on a motherboard or other portion of a computing device, on an integrated circuit, such as a system on a chip (SoC), etc.), components integrated within one another (e.g., processor 124 can include the memory 126 as an on-board component 121), and/or the like. Memory 126 may store instructions, parameters, data structures, etc., for use/execution by processor 124 to perform functions described herein.

In an example, computing device 120 can execute an operating system 128 (e.g., via processor 124 and/or memory 126) for providing an environment for executing one or more applications, such as a policy configuring environment 130 for providing an interface to facilitate high-level virtual network policy management, and/or a SDN compiler 132 for compiling high-level virtual network policies, generated using policy configuring environment 130 or otherwise received at the computing device 120, into low-level intermediate representation instructions.

SDN compiler 132 can include a policy obtaining component 140 for obtaining one or more high-level virtual network policies (e.g., from a policy configuring environment 130, deriving a policy based on a SDN configuration, and/or the like), an instruction generating component 142 for generating a set of low-level intermediate representation instructions based on the high-level virtual network policy, and a SDN managing component 144 for managing an SDN (e.g., via an SDN function 112 and/or an associated configuration 114) based on the set of low-level intermediate representation instructions, which can include attempting to achieve a goal state inferred from the set of low-level intermediate representation instructions.

Though shown as part of one computing device 120, the policy configuring environment 130, SDN compiler 132, and/or components thereof may be part of various computing devices to may or may not be in communication with one another. For example, a different computing device may generate the high-level virtual network policy via its policy configuring environment 130 (or via a remotely-accessed environment 130, etc.), and the generated high-level virtual network policy may be provided to the computing device 120 for processing. In addition, for example, computing device 120 may provide the SDN function 112 or can operate another device to provide the SDN function 112 for virtual network 110.

FIG. 2 is a flowchart of an example of a method 200 for compiling high-level virtual network policies into low-level intermediate representation instructions. For example, method 200 can be performed by the computing device 120, and is accordingly described with reference to FIG. 1, as a non-limiting example of an environment for carrying out method 200.

In method 200, optionally at action 202, a current network state of a set of virtual networks can be determined. In an example, policy obtaining component 140, e.g., in conjunction with processor 124, memory 126, operating system 128, SDN compiler 132, etc., can determine the current network state of the set of virtual networks. For example, policy obtaining component 140 can determine the current network state based on a high-level virtual network policy (e.g., for a set of managed virtual networks), based on one or more parameters in a network configuration (e.g., for a set of unmanaged virtual networks), and/or the like.

In one example, in determining the current network state at action 202, optionally at action 204, a high-level virtual network policy can be generated or received for a managed network. In an example, policy configuring environment 130 can generate, and/or policy obtaining component 140 can receive, e.g., in conjunction with processor 124, memory 126, operating system 128, SDN compiler 132, etc., the high-level virtual network policy for the managed network. For example, policy configuring environment 130 can provide an environment, user interfaces, etc. to allow for user input to specify a high-level virtual network policy. For example, policy configuring environment 130 can allow for specifying associations between nodes of the set of virtual networks, associations between the virtual networks themselves, etc. to indicate peering, segmentation, routing, isolation, security policy, etc., as described. The high-level virtual network policy can be generated to include abstractions to allow users to indicate a policy intent for the set of virtual networks. In addition, in an example, policy obtaining component 140 can receive the high-level virtual network policy, whether received as generated by policy configuring environment 130 or received from another device/environment. In one example, the high-level virtual network policy can be optionally received as an indication of the current network state, and may be received and/or recalled from a previous virtual network configuring operation.

In another example, in determining the current network state at action 202, optionally at action 206, the current network state of an unmanaged set of virtual networks can be determined. In an example, policy obtaining component 140 can determine the current state of the unmanaged set of virtual networks. For example, policy obtaining component 140 can determine parameters of a network configuration for the unmanaged set of virtual networks, and can translate the parameters into a high-level virtual network policy. In an example, policy obtaining component 140 can evaluate ACLs, rules, groups, etc. in a current network configuration for the set of unmanaged networks, and can infer one or more high-level virtual network policy parameters or abstractions based on the ACLs, rules, groups, etc., such as peering or routing information, security policies, and/or the like. This can allow for making an unmanaged network managed by the SDN function 112 configured via the SDN compiler 132, as described further herein.

In method 200, at action 208, an indicated change to the current network state can be detected based on obtaining at least a portion of a high-level virtual network policy. In an example, policy obtaining component 140, e.g., in conjunction with processor 124, memory 126, operating system 128, SDN compiler 132, etc., can detect, based on obtaining at least a portion of a high-level virtual network policy, an indicated changed to the current network state. For example, policy obtaining component 140 can detect the indicated change based at least in part on the portion of the high-level virtual network policy that is obtained for modifying the configuration, which can include one or more modified parameters of the high-level virtual network policy (e.g., as obtained from a policy configuring environment 130), as opposed to necessarily the entire high-level virtual network policy.

In one example, in detecting the indicated change at action 208, optionally at action 210, a new high-level virtual network policy can be compared to the current network state. For example, policy configuring environment 130 can compare the new high-level virtual network policy to the current network to detect the indicated change. In one example, policy obtaining component 140 can compare the new high-level virtual network policy to a current high-level virtual network policy, which defines the current network state, to detect one or more differences between the two policies, and can accordingly determine the indicated change (e.g., as adding, removing, or otherwise modifying one or more high-level virtual network policy parameters or abstractions). In another example, policy obtaining component 140 can compare the new high-level virtual network policy to a current network configuration for an unmanaged network (e.g., that indicates ACLs, rules, groups, etc.), and can determine the indicated change (e.g., as adding, removing, or otherwise modifying one or more high-level virtual network policy parameters or abstractions to the current network configuration by compiling the one or more high-level virtual network policy parameters into low-level intermediate representation instructions, as described further herein).

In other examples, the comparison can be performed at lower levels, such as by comparing a current set of low-level intermediate representation instructions defining the current network state to a set of low-level intermediate representation instructions compiled from the high-level virtual network policy or one or more related parameters. Based on the comparison, for example, SDN compiler 132 can determine whether to add, remove, or otherwise modify low-level intermediate representation instructions based on comparing the sets, as described further herein.

In method 200, at action 212, at least a portion of the high-level virtual network policy can be compiled, based on detecting the indicated change, to generate a set of low-level intermediate representation instructions. In an example, instruction generating component 142, e.g., in conjunction with processor 124, memory 126, operating system 128, SDN compiler 132, etc., can compile, based on detecting the indicated change (e.g., by policy obtaining component 140, as described above), at least the portion of the high-level virtual network policy to generate the set of low-level intermediate representation instructions. In this regard, for example, SDN compiler 132 can define a language of abstractions that can be specified in the high-level virtual network policy and can accordingly be translated to a set of low-level intermediate representation instructions used to institute the policy, which may include configuring an SDN function 112 in attempting to achieve a goal state intended by the set of low-level intermediate representation instructions.

In an example, in compiling at least the portion of the high-level virtual network policy at action 212, optionally at action 214, one or more high-level virtual network policy parameters can be determined. In an example, instruction generating component 142, e.g., in conjunction with processor 124, memory 126, operating system 128, SDN compiler 132, etc., can determine the one or more high-level virtual network policy parameters. For example, instruction generating component 142 can determine the one or more high-level virtual network policy parameters for compiling into the set of low-level intermediate representation instructions. In this regard, for example, instruction generating component 142 may not compile all of the high-level virtual network policy, but rather may compile only certain parameters or abstractions, such as those representing a change in the policy. As described, this determination and/or comparison to low-level intermediate representation instructions of a current network state to determine parameters to add/remove/modify from the policy can occur at the policy level, at the low-level intermediate representation level, etc.

In addition, for example, determining the one or more high-level virtual network policy parameters may include determining the parameters corresponding to a current state of an unmanaged set of virtual networks, as described (e.g., determining one or more high-level virtual network policy parameters to which parameters in a current network configuration, such as ACLs, rules, groups, etc., can be translated). In this example, these parameters can be compiled into the set of low-level intermediate representation instructions to bring the unmanaged set of virtual networks into a managed set of virtual networks (e.g., by foregoing the current unmanaged network configuration and instead applying the set of low-level intermediate representation instructions to the configuration 114 of the SDN function 112, as described further herein).

Also, in an example, in compiling at least the portion of the high-level virtual network policy at action 212, optionally at action 216, one or more permissions can be verified. In an example, SDN compiler 132, e.g., in conjunction with processor 124, memory 126, operating system 128, etc., can verify the one or more permissions for the high-level network policy before corresponding instructions are generated. For example, SDN compiler 132 can verify whether a user or corresponding account that has generated or is attempting to modify the high-level security policy has permission to do so before generating the corresponding intermediate representation. Where the one or more permissions cannot be verified for the high-level security policy (e.g., where the user or account under which the policy or change thereto is authored is not allowed to generate the policy or make the change), SDN compiler 132 can refrain from generating the low-level intermediate representation instructions corresponding to the policy or the change thereto, and/or can refrain from generating the low-level intermediate representation instructions corresponding specifically to the portion of the policy that the user does not have permissions to generate/modify, etc. In an example, the permissions can be specified per user account or associated user group. In one example, the high-level network policy can include the specification of the permissions, and SDN compiler 132 may determine the permissions to be verified/applied based on associated syntax for the permissions. In other examples, the permissions may not refer to a specific user/account, but may be applicable for any user/account generating the policy and/or the associated change.

In method 200, at action 218, the set of low-level intermediate representation instructions can be applied in a network configuration for managing the set of virtual networks. In an example, SDN managing component 144, e.g., in conjunction with processor 124, memory 126, operating system 128, SDN compiler 132, etc., can apply the set of low-level intermediate representation instructions in the network configuration for managing the set of virtual networks. For example, SDN managing component 144 can apply the set of low-level intermediate representation instructions by configuring the configuration 114 of the SDN function 112 based on the set of low-level intermediate representation instructions. For example, given the set of low-level intermediate representation instructions to provide an association between nodes of the virtual networks, SDN managing component 144 can accordingly modify the configuration 114 to include the association.

In this regard, in applying the set of low-level intermediate representation instructions at action 218, optionally at action 220, a SDN configuration can be modified to achieve a goal state. For example, SDN managing component 144 can modify the configuration 114 to achieve the goal state that is indicated or intended by the high-level virtual network policy, as described above. In this regard, SDN function 112 can operate the virtual network 110 according to the configuration 114 such to achieve, or attempt to achieve, the goal state. In an example, SDN managing component 144 can determine whether the goal state is being achieved by the virtual network 110, and if not may modify the configuration 114 in an attempt to achieve the goal state. For example, where underlying associations between nodes are modified, this may impact other associations. SDN managing component 144 can detect such modifications or failure of the virtual network 110 to achieve the goal state indicated by the high-level virtual network policy, and may accordingly modify the configuration 114 to establish the associations specified in the high-level virtual network policy and/or the corresponding set of low-level intermediate representation instructions.

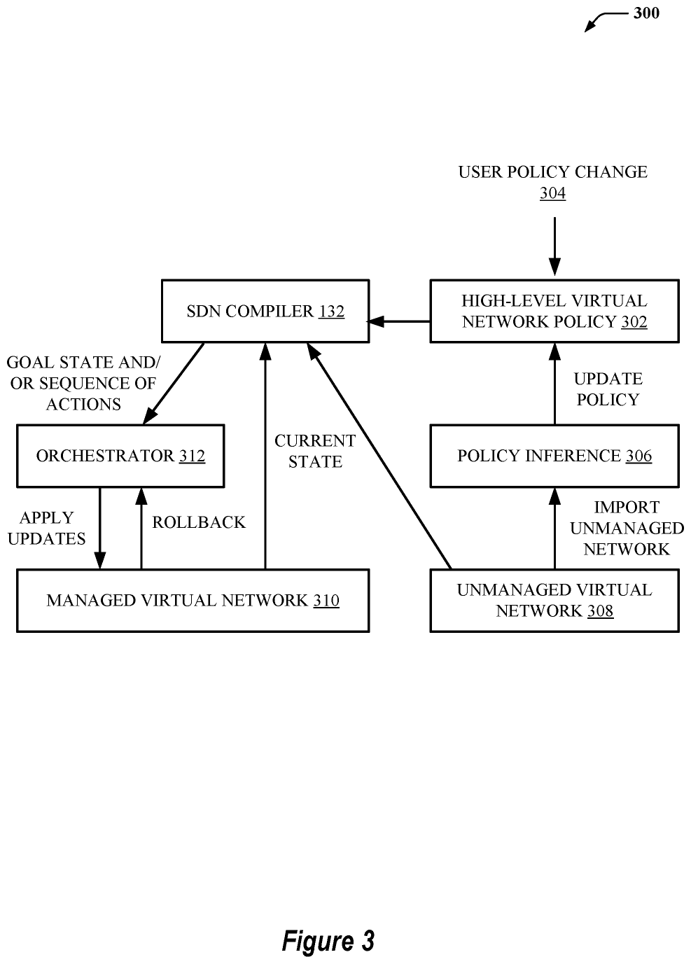

FIG. 3 illustrates an example of a process flow 300 of compiling a high-level virtual network policy and/or related parameters into a set of low-level intermediate representation instructions to modify a managed virtual network. In process flow 300, SDN compiler 132 can receive a high-level virtual network policy 302, or at least information regarding a modification thereto, for compiling into the set of low-level intermediate representation instructions, as described. For example, the high-level virtual network policy 302 can be modified and/or generated based on a user policy change 304. As described, for example, the user policy change may be received and/or identified via a policy configuring environment 130. In another example, as described, the high-level virtual network policy 302 can be modified and/or generated based on a policy inference 306 performed for an unmanaged virtual network 308. For example, policy obtaining component 140 can perform the policy inference 306, as described, to determine high-level virtual network policy parameters that correspond to the current network state of the unmanaged virtual network 308 (e.g., based on translating ACLs, rules, groups, etc. into the high-level virtual network policy parameters).

In any case, SDN compiler 132 can obtain the high-level virtual network policy 302, or at least a modified portion thereof. For example, the high-level virtual network policy 302 may include instructions and/or abstractions for adding, removing, modifying, etc. associations among nodes of the set of virtual networks. SDN compiler 132 can generate, from the high-level virtual network policy, a goal state and/or a corresponding sequence of actions (e.g., which may be represented by the set of low-level intermediate representation instructions. An orchestrator 312, which may be similar to SDN managing component 144, can apply updates to, and/or rollback previous actions from, a managed virtual network 310 (and/or bring the unmanaged virtual network 308 into a managed virtual network 310) based on the goal state and/or a corresponding sequence of actions. For example, this can include implementing SDN configuration modifications to achieve the goal state, such as ACLs, rules, groups, etc., as described.

In addition, in an example, SDN compiler 132 can receive or determine a current network state of the unmanaged virtual network 308 (e.g., via policy obtaining component 140 translating network configuration into high-level virtual network policy parameters) or of the managed virtual network 310 (e.g., via a currently stored high-level virtual network policy currently being orchestrated), etc., and can accordingly modify the current network state, as described herein.

In this example, SDN compiler 132 can be invoked when there is a detected change to the virtual network policy, which may occur by user policy change 304 via an interface, when the unmanaged virtual network 308 is to become managed, etc. The SDN compiler 132 can take the current high-level virtual network policy 302 as input as well as the current network state (which can be determined or based on a stored high-level virtual network policy), as described. The SDN compiler 132 can generate the desired goal state for the network given the policy and/or a sequence of actions that can move the network to that state (e.g., add, remove, or otherwise modify a peering policy, a NSG, etc.). The actions can move the set of virtual networks to the goal state in a way that is consistent with the current network state. For example, the SDN compiler 132 may determine not to add security group that blocks existing user traffic before a new rule is set up to route according to the new high-level virtual network policy. The orchestrator 312 can be responsible for atomically applying these actions. By using a SDN compiler 132 in this regard to institute network configuration based on high-level virtual network policy specifications, configuring the network can become easier for administrators to achieve desired functionality, and can offer correct-by-construction guarantees by automating the associated configuration modifications. In addition, the SDN compiler 132 can transition the network between states based on high-level virtual network policy modification without further action by the administrator.

In a specific example, the high-level virtual network policy 302 may describe a hub-and-spoke network configuration for the virtual network where one node is identified as a hub, and multiple nodes communicate with the hub, and a full mesh network where each node is connected with one another (and/or may include some exceptions to the full mesh). In this example, high-level virtual network policy 302 may define syntax similar to the following to describe hub-and-spoke and full mesh configurations:

```
define scope = { s1.*, s2.*}
(hub-and-spoke h s)
  define h = s1.v1
  define s = { s2.v1, s2.v2 }
((full-mesh g)
  define g = { s1.v1, s1.v2, s1.v3 }
  except {(s1.v2, s1.v3)})
```

This syntax can define 1) a hub-and-spoke network h s where the hub is s1.v1 and spokes to the hub are s2.v1 and s2.v2, and 2) a full mesh network g where nodes s1.v1, s1.v2, and s1.v3 are all connected to one another except there is no direct connection between s1.v2 and s1.v3. In addition, for example, a peering can be defined as follows:

Peering=(hub-and-spoke h s)+(full-mesh g)−{(s1.v2,s1.v3)}

Given the above high-level virtual network policy syntax, for example, SDN compiler 132 can generate a set of low-level intermediate representation instructions to achieve a goal state intended by the high-level virtual network policy syntax. For example, SDN compiler 132 can define the set of low-level intermediate representation instructions as associations between nodes based on the hub-and-spoke and full mesh networks as:

```
{
  (s1.v1, s2.v1),
  (s1.v1, s2.v2),
  (s1.v1, s1.v2),
  (s1.v1, s1.v3)
}
```

SDN compiler 132 may also define, in the set of low-level intermediate representation instructions, peerings as:

+(s1.v1,s2.v1)

+(s1.v1,s2.v2)

+(s1.v1,s1.v2)

+(s1.v1,s1.v3)

The orchestrator 312 can accordingly add ACLs, rules, groups, etc. based on the associations and/or peerings defined above, and/or as specified in the corresponding set of low-level intermediate representation instructions, to move the set of virtual networks toward the goal state.

In another example, SDN compiler 132 can detect updates to the high-level virtual network policy, and can accordingly modify the corresponding set of low-level intermediate representation instructions based on the updates. For example, given the following updated policy for the above example:

define scope={s1.*,s2.*}

define h=s1.v1

define s={s2.v1,s2.v2}

define g={s1.v1,s1.v2,s1.v3}

peering=(hub-and-spoke h s)+(full-mesh g)}

where the “except” statement is removed, SDN compiler 132 can define the set of low-level intermediate representation instructions as associations between nodes based on the hub-and-spoke and full mesh networks as:

```
{
  (s1.v1, s2.v1),
  (s1.v1, s2.v2),
  (s1.v1, s1.v2),
  (s1.v1, s1.v3),
  (s1.v2, s1.v3)
}
```

such to add (s1.v2, s1.v3). In addition, SDN compiler 132 may also define, in the set of low-level intermediate representation instructions, a new associated peering as:

+(s1.v2,s2.v3)

and the orchestrator 312 can add appropriate ACLs, rules, groups, etc. to effectuate the new peering.

In another example, the high-level virtual network policy may be modified by adding another subset s3. For example, given the following updated policy for the above example:

define scope={s1.*,s2.*,s3.*}

define h=s1.v1

define s={s2.v1,s2.v2}

define g={s1.v1,s1.v2,s1.v3}

peering=(hub-and-spoke h s)+(full-mesh g)}

SDN compiler 132 can define the set of low-level intermediate representation instructions as associations between nodes based on the hub-and-spoke and full mesh networks as:

```
{
  (s1.v1, s2.v1),
  (s1.v1, s2.v2),
  (s1.v1, s1.v2),
  (s1.v1, s1.v3),
  (s1.v2, s1.v3),
  (s3.v1, s3.v2)
}
```

where metadata can indicate an existing peering from S3 from a current SDN state. In one example, however, another updated policy may remove peering from S3 via the following policy:

define scope={s1.*,s2.*,s3.*}

define h=s1.v1

define s={s2.v1,s2.v2}

define g={s1.v1,s1.v2,s1.v3}

peering=(hub-and-spoke h s)+(full-mesh g)}−{(s3.v1,s3.v2)}

which may result in the following intermediate representation:

```
{
  (s1.v1, s2.v1),
  (s1.v1, s2.v2),
  (s1.v1, s1.v2),
  (s1.v1, s1.v3),
  (s1.v2, s1.v3)
}
```

and may remove the following peering:

−(s3.v1,s3.v2)

and the orchestrator 312 can remove appropriate ACLs, rules, groups, etc.

In addition, in an example, a portion of the set of low-level intermediate representation instructions and/or other explanation of changes made (or that will be made) to the configuration 114 based on the updated high-level virtual network policy may be presented (e.g., via policy configuring environment 130 or another interface). This can allow an administrator an opportunity to review and approve the changes before the orchestrator 312 institutes changes to the configuration 114 to achieve the goal state.

Moreover, as described, the low-level intermediate representation instructions may be defined to allow for recovering the high-level virtual network policy therefrom, which can be represented in a policy configuring environment 130 to allow changes to be specified via the environment 130. For example, the low-level intermediate representation instructions can be generated to include metadata to allow for recovering the corresponding policy, such as a type of network associated with peerings (e.g., hub-and-spoke or full mesh), unique identifiers for expressions or sub-expressions from the original policy that contributed to addition or removal of a peering, or other parameters regarding the various associations, policies, etc.

In the above examples, peering is described as a non-limiting example of how the SDN compiler 132 can generate, given a high-level network policy, the desired goal state for the network and/or a sequence of actions that can move the network to that state. The SDN compiler 132 can similarly generate similar abstractions for routing, security, and/or other desired goal states. In a specific example, security policies can be declared including network security groups associated with a network interface card, subnet, or virtual machine, or application security groups associated with groups of network interface cards, virtual machines, etc. Each security group can have a set of defined rules for allowing or prohibiting communications among nodes or groups of nodes. Typically, these groups are limited to nodes within a single virtual network. Using the SDN compiler 132 to understand high-level network policy, however, can enable desired security group logic and/or groups that span more than one virtual network. For example, a high-level network policy may define non-local security tables that can govern a set of devices and/or a general grouping mechanism for grouping arbitrary network elements. The SDN compiler 132 can include logic to receive the policy and accordingly implement rules to establish the security groups.

For example, the SDN compiler 132 may allow a high-level network policy having syntax for specifying a single global security group to capture commonalities among multiple security groups, and the SDN compiler 132 can generate the intermediate representation to include individual security policy instructions representative of the global security group. For example, the high-level network policy may create a Group A with nodes VM1, VM2, VM3, VM4, and Group B with nodes S1, S2, S3, and S4 (e.g., using peering syntax described above or otherwise). In addition, the high-level network policy may specify a security policy for the groups, such as allow traffic from Group A to Group B except for UDP traffic. In this example, the high-level network policy may define syntax representing the following policy:

| Src | Dst | SrcPort | DstPort | Protocol | Action |
|---|---|---|---|---|---|
| A | B | * | * | UDP | Deny |
| A | B | * | * | * | Allow |

where Src indicates the source group, Dst indicates the destination group, SrcPort indicates the source IP port (and “*” indicates all ports), DstPort indicates the destination port. Thus, in this example, all traffic from Group A to Group B is allowed by the second table entry, and UDP traffic is forbidden by the first entry.

In this example, SDN compiler 132 can generate, for this high-level network policy, intermediate representation instructions for each node in each group to institute the policy, where the SDN managing component 144 can apply the set of intermediate representation instructions in the network configuration (e.g., configuration 114) for managing the set of virtual networks (e.g., via SDN function 112, as described above). For example, for each node in Group A, SDN compiler 132 can generate intermediate representation instructions that institute the following:

| Src | Dst | SrcPort | DstPort | Protocol | Action |
|---|---|---|---|---|---|
| Any | B | * | * | UDP | Deny |
| Any | B | * | * | * | Allow |

and for each node in Group B, SDN compiler 132 can generate intermediate representation instructions that institute the following:

| Src | Dst | SrcPort | DstPort | Protocol | Action |
|---|---|---|---|---|---|
| A | Any | * | * | UDP | Deny |
| A | Any | * | * | * | Allow |

In other examples, other syntax can be used. For example, SDN compiler 132 may allow syntax to create security policy rules in both directions (e.g., one rule or table entry specifying end points and the port or protocol for which traffic is allowed/denied, etc.). Moreover, as described, for updates to the security policy or the group members, SDN compiler 132 can add, remove, and/or modify the intermediate representation instructions to effectuate the updates.

In another example, SDN compiler 132 can verify permissions for the high-level network policy specification and/or changes, as described. Thus, for example, the permissions may include one or more invariants by which the high-level network policy must comply. In security groups, for example, one or more invariants may be specific to a given group, such as no blocking on a certain IP port. In this regard, SDN compiler 132 can ensure that the intermediate representation instructions generated from the high-level network policy comply with the invariant(s) for each corresponding group. Where instructions do not comply, the SDN compiler 132 may refrain from generating the specific instruction(s) that do not comply, may terminate generating of the intermediate representation instruction for the policy altogether, etc.

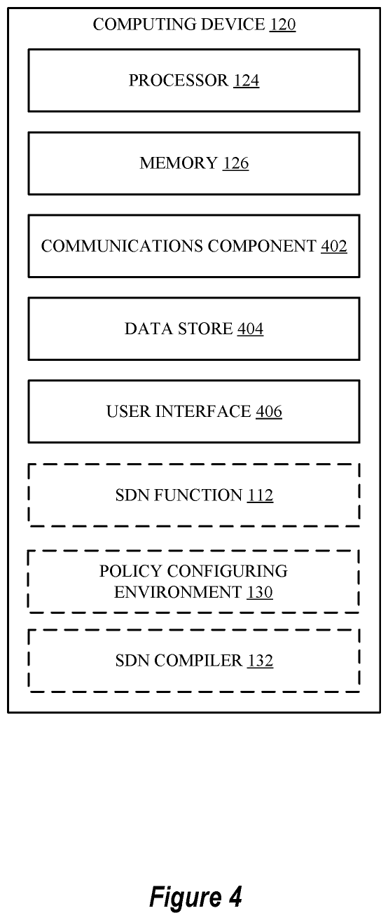

FIG. 4 illustrates an example of computing device 120 including additional optional component details as those shown in FIG. 1. In one example, computing device 120 may include processor 124 for carrying out processing functions associated with one or more of components and functions described herein. Processor 124 can include a single or multiple set of processors or multi-core processors. Moreover, processor 124 can be implemented as an integrated processing system and/or a distributed processing system.

Computing device 120 may further include memory 126, such as for storing local versions of applications being executed by processor 124, related instructions, parameters, etc. Memory 126 can include a type of memory usable by a computer, such as random access memory (RAM), read only memory (ROM), tapes, magnetic discs, optical discs, volatile memory, non-volatile memory, and any combination thereof. Additionally, processor 124 and memory 126 may include and execute an operating system executing on processor 124, one or more applications, such as an SDN function 112, policy configuring environment 130, SDN compiler 132, and/or components thereof, as described herein, and/or other components of the computing device 120.

Further, computing device 120 may include a communications component 402 that provides for establishing and maintaining communications with one or more other devices, parties, entities, etc. utilizing hardware, software, and services as described herein. Communications component 402 may carry communications between components on computing device 120, as well as between computing device 120 and external devices, such as devices located across a communications network and/or devices serially or locally connected to computing device 120. For example, communications component 402 may include one or more buses, and may further include transmit chain components and receive chain components associated with a wireless or wired transmitter and receiver, respectively, operable for interfacing with external devices. For example, communications component 402 can carry communications between SDN function 112, policy configuring environment 130, SDN compiler 132, etc. executing on another device (or the same device), etc., as described in various examples herein.

Additionally, computing device 120 may include a data store 404, which can be any suitable combination of hardware and/or software, that provides for mass storage of information, databases, and programs employed in connection with examples described herein. For example, data store 404 may be or may include a data repository for applications and/or related parameters not currently being executed by processor 124. In addition, data store 404 may be a data repository for an operating system, application, such as SDN function 112, policy configuring environment 130, SDN compiler 132, and/or components thereof, etc. executing on the processor 124, and/or one or more other components of the computing device 120.

Computing device 120 may also include a user interface component 406 operable to receive inputs from a user of computing device 120 and further operable to generate outputs for presentation to the user (e.g., via a display interface to a display device). User interface component 406 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, any other mechanism capable of receiving an input from a user, or any combination thereof. Further, user interface component 406 may include one or more output devices, including but not limited to a display interface, a speaker, a haptic feedback mechanism, a printer, any other mechanism capable of presenting an output to a user, or any combination thereof.

Computing device 120 can also include a SDN function 112 for providing or managing a virtual network, a policy configuring environment 130 for providing a mechanism (e.g., a collection of user interfaces) for generating a high-level virtual network policy, and/or a SDN compiler 132 for compiling high-level virtual network policies into a set of low-level intermediate representation instructions for applying to a SDN configuration, as described herein.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more examples, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various examples described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for managing a set of virtual networks, comprising:
determining a current network state of the set of virtual networks;
detecting, based at least in part on obtaining at least a portion of a high-level virtual network policy, an indicated change to the current network state;
compiling, based on detecting the indicated change, at least a portion of the high-level virtual network policy to generate a set of low-level intermediate representation instructions to implement the indicated change to the high-level virtual network policy; and
applying the set of low-level intermediate representation instructions in a network configuration for managing the set of virtual networks.

2. The computer-implemented method of claim 1, wherein determining the current network state comprises generating or receiving the high-level virtual network policy for a managed network.

3. The computer-implemented method of claim 2, wherein detecting the indicated change comprises detecting the indicated change as indicated via a user interface.

4. The computer-implemented method of claim 1, wherein determining the current network state comprises inferring, based on a current network configuration, the current network state of the set of virtual networks as unmanaged virtual networks.

5. The computer-implemented method of claim 4, wherein detecting the change is based on determining to manage the unmanaged virtual networks.

6. The computer-implemented method of claim 1, wherein determining the current network state comprises determining a previous set of low-level intermediate representation instructions representing the current network state, and wherein compiling the high-level virtual network policy comprises adding one or more low-level intermediate representation instructions to, removing one or more low-level intermediate representation instructions from, or modifying one or more low-level intermediate representation instructions of, the previous set of low-level intermediate representation instructions to generate the set of low-level intermediate representation instructions.

7. The computer-implemented method of claim 6, wherein determining the current network state comprises generating the previous set of low-level intermediate representation instructions based on one or more parameters specified in a configuration of the set of virtual networks as unmanaged virtual networks.

8. The computer-implemented method of claim 1, wherein compiling the high-level virtual network policy comprises determining one or more high-level virtual network policy parameters, and wherein generating the set of low-level intermediate representation instructions is based on the one or more high-level virtual network policy parameters.

9. The computer-implemented method of claim 8, wherein compiling the high-level virtual network policy comprises determining whether the set of low-level intermediate representation instructions exist in a current set of low-level intermediate representation instructions corresponding to the current network state.

10. The computer-implemented method of claim 1, wherein the indicated change to the high-level virtual network policy includes specifying an association between two or more virtual networks in the set of virtual networks, and wherein compiling the high-level virtual network policy comprises generating the set of low-level intermediate representation instructions to add, in a software-defined network (SDN) configuration, an indication of the association between the two or more virtual networks.

11. The computer-implemented method of claim 1, wherein applying the set of low-level intermediate representation instructions in the network configuration comprises determining a goal state for the set of virtual networks based on the set of low-level intermediate representation instructions, and modifying a software-defined network (SDN) configuration to achieve the goal state.

12. A computing device for managing a set of virtual networks, comprising:
a memory storing one or more parameters or instructions for compiling source code; and
at least one processor coupled to the memory, wherein the at least one processor is configured to:
determine a current network state of the set of virtual networks;
detect, based at least in part on obtaining at least a portion of a high-level virtual network policy, an indicated change to the current network state;
compile, based on detecting the indicated change, at least a portion of the high-level virtual network policy to generate a set of low-level intermediate representation instructions to implement the indicated change to the high-level virtual network policy; and
apply the set of low-level intermediate representation instructions in a network configuration for managing the set of virtual networks.

13. The computing device of claim 12, wherein the at least one processor is configured to determine the current network state at least in part by at least one of generating or receiving the high-level virtual network policy for a managed network or inferring, based on a current network configuration, the current network state of the set of virtual networks as unmanaged virtual networks.

14. The computing device of claim 12, wherein the at least one processor is configured to determine the current network state at least in part by determining a previous set of low-level intermediate representation instructions representing the current network state, and wherein the at least one processor is configured to compile the high-level virtual network policy at least in part by adding one or more low-level intermediate representation instructions to, removing one or more low-level intermediate representation instructions from, or modifying one or more low-level intermediate representation instructions of, the previous set of low-level intermediate representation instructions to generate the set of low-level intermediate representation instructions.

15. The computing device of claim 14, wherein the at least one processor is configured to determine the current network state at least in part by generating the previous set of low-level intermediate representation instructions based on one or more parameters specified in a configuration of the set of virtual networks as unmanaged virtual networks.

16. The computing device of claim 12, wherein the at least one processor is configured to compile the high-level virtual network policy at least in part by determining one or more high-level virtual network policy parameters, and wherein the at least one processor is configured to generate the set of low-level intermediate representation instructions based on the one or more high-level virtual network policy parameters.

17. The computing device of claim 12, wherein the at least one processor is configured to compile the high-level virtual network policy at least in part by determining whether the set of low-level intermediate representation instructions exist in a current set of low-level intermediate representation instructions corresponding to the current network state.

18. The computing device of claim 12, wherein the at least one processor is configured to apply the set of low-level intermediate representation instructions in the network configuration at least in part by determining a goal state for the set of virtual networks based on the set of low-level intermediate representation instructions, and modifying a software-defined network (SDN) configuration to achieve the goal state.

19. A non-transitory computer-readable medium, comprising code executable by one or more processors for managing a set of virtual networks, the code comprising code for:
determining a current network state of the set of virtual networks;
detecting, based at least in part on obtaining at least a portion of a high-level virtual network policy, an indicated change to the current network state;
compiling, based on detecting the indicated change, at least a portion of the high-level virtual network policy to generate a set of low-level intermediate representation instructions to implement the indicated change to the high-level virtual network policy; and
applying the set of low-level intermediate representation instructions in a network configuration for managing the set of virtual networks.

20. The non-transitory computer-readable medium of claim 19, wherein the code determining the current network state at least one of generates or receives the high-level virtual network policy for a managed network, or infers, based on a current network configuration, the current network state of the set of virtual networks as unmanaged virtual networks.
